(19) United States
(12) Patent Application Publication
(10) Pub. No.: US 2021/0329007 A1
(43) Pub. Date: Oct. 21, 2021

(54) Method of Using Sequential Email Numbering to Detect an Email Phishing Attempt or Fraudulent Email Within an Email Domain

(71) Applicant: William Michael Pearce, Toronto (CA)

(72) Inventor: William Michael Pearce, Toronto (CA)

(21) Appl. No.: 16/704,569

(22) Filed: Dec. 5, 2019

(51) Int. Cl. H04L 29/06; G06F 16/2458; H04L 12/58

(52) U.S. Cl. CPC H04L 63/126; H04L 63/1483; H04L 51/30; G06F 16/2471; H04L 63/1416

(57) ABSTRACT

Herein is disclosed a method of verifying the authenticity of emails sent within an email domain from a first email application of a sender to a second email application of a recipient, the emails each having a sender's email address, a receiver's email address, and a user-accessible field for receiving content. The content of the user-accessible field is visible to the recipient upon opening an email inbox in the second email application. The method includes the steps of first identifying the receiver for an email to be sent by the sender. A current sequence marker for the receiver is then generated. The current sequence marker represents a next sequence identifier in a sequence of emails between the sender and the receiver. The current sequence marker is then inserted into the user-accessible field of the email and the email is then sent.

### CROSS-REFERENCE TO RELATED APPLICATION

This is a continuation-in-part of U.S. application Ser. No. 16/399,321 filed Apr. 30, 2019, the entirety of which is incorporated herein by reference.

### BACKGROUND OF THE INVENTION

Modern enterprises, organizations, groups, businesses and corporations of all types and sizes rely on internal email communications (“corporate email”) to manage projects, allow company personnel in different physical locations to collaborate, disseminate corporate news and policies, and for many other purposes. Typically, a company's email service (“email domain”) is provided through one or more email servers that facilitate the hosting and the forwarding and exchange of email between staff members. These servers may be under the direct control of the company, or may be furnished through a third party contracted for the purpose. In either case, the effect is the same: the provision of email service within the corporate environment, eliminating the need for staff to use external email providers such as Gmail or Hotmail in order to communicate with each other.

It is beneficial for businesses to assist their personnel with identifying fraudulent emails and help them not be deceived by emails that appear to be legitimate but that are actually phishing attempts, spear-phishing attempts, or other fraudulent emails originating from bad actors with nefarious intents and purposes, such as (i) emails with a forged sender address that is spoofed to appear to come from another email sender, or (ii) clone phishing attempts where an attachment or website link within an email is replaced with a malicious version of the email that claims to be a resend of the original or an updated version to the original, or (iii) other email phishing and fraudulent email attack techniques.

These types of emails typically originate from outside the company and are routed to the company's email domain by the Simple Mail Transfer Protocol (“SMTP”) and other standards or proprietary methods for transporting email, as per rules set within the email domain. Attempts to impersonate or masquerade as legitimate intra-domain email traffic can evade the conventional filters in the email domain and have the potential to arrive without detection in the in-boxes of targeted email recipients unless a system such as the present invention is in place.

An innovation that would assist in identifying potential phishing attempts and fraudulent emails within a company's internal email traffic would be a benefit. Any email sender would benefit from this innovation, but businesses with their own email domains, in particular, would benefit by increasing the safety and security of their email environment against phishing attempts and fraudulent emails, thus allowing their staff to communicate more freely and reducing their concerns about the inadvertent disclosure of company information that might be sensitive, proprietary, subject to legal restrictions, or otherwise inappropriate for dissemination outside the company.

### SUMMARY OF THE PRESENT INVENTION

The present invention overcomes the disadvantages of the prior art by providing a method of verifying the authenticity of emails allegedly sent between parities in the same email domain by verifying the sequential history of the email correspondence between the parties. The emails each have a sender's email address, a receiver's email address, and a user-accessible field such as the subject field. The method of the present invention includes the steps of identifying the receiver for an email to be sent by the sender and then generating a current sequence marker for the receiver. The current sequence marker represents a next predicted sequence identifier in a sequence of emails between the sender and receiver. For example, if the sequence of emails between the sender and receiver includes 76 messages and the sequence marker is configured to be a numeric integer, then the last sequence identifier used could be 76 in which case the next sequence identifier (76+1, or 77) would result in the current sequence marker being 77. The next step in the method is to insert the current sequence marker into the user-accessible field of the email and then sending the email to the recipient. Preferably the sequence marker is formed from a sequence of alphanumeric characters which are human readable. Preferably the sequence marker is inserted into the subject line of the email allowing the receiver to verify the presence and veracity of the sequence identifier without having to open the email.

With the foregoing in view, and other advantages as will become apparent to those skilled in the art to which this invention relates as this specification proceeds, the invention is herein described by reference to the accompanying drawing fruiting a part hereof, which includes a description of the preferred typical embodiment of the principles of the present invention.

### DESCRIPTION OF THE DRAWINGS

FIG. 1 is a schematic view of the system of the present invention showing the system of the present invention being used to send an email from a Sender A to a Recipient B.

FIG. 2 is a schematic view of the system of the present invention being used to send an email,

FIG. 3 is a schematic view of the system of the present invention being used to receive an email.

In the drawings like characters of reference indicate corresponding parts in the different figures.

### DETAILED DESCRIPTION OF TI-IE INVENTION

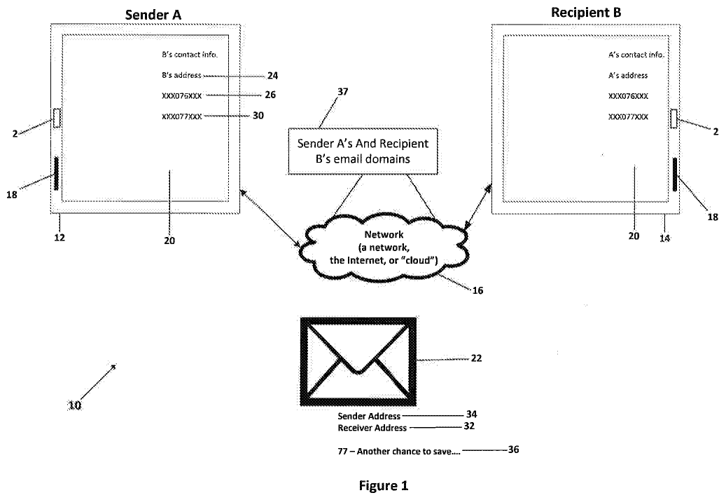

Referring firstly to FIG. 1, the present invention relates to the exchange of emails between users in an organization which is set up to send email messages in bulk such as a public or private company, a government agency, an association, an educational institution, an email service provider or any other email network where all of the users have email addresses having the same email domain (hereafter referred to as the Company). The Company may also include a web-based email service provider, which provides web-based email addresses to a plurality of remote users all with the same email domain. Such web-based email service providers include Yahoo Mail, Gmail, Hotmail and others. The system of the present invention, shown generally as item 10, consists of two email-capable computing devices 12 and 14 in communication with each other via a network 16. Network 16 is furnished by the Company for the use of its employees (users) and for other corporate purposes. Network 16 could be a telecom network or cellular data network or a local area network, but for most practical applications, network 16 is the internet.

Network 16 is capable of facilitating Simple Mail Transfer Protocol (RFC-5321) for email using Transmission Control Protocol (“TCP”), or other standards or proprietary methods of transporting email, that can send Sender A's email 22 to the Company's email domain 37. The

Company's email domain 37 then forwards Sender A's email 22 via Network 16, again using Simple Mail Transfer Protocol or other standards or proprietary methods of transporting email, to Recipient B's email application 18.

The Company's email domain 37 incorporates servers and processes compliant with the respective RFC protocols and standards for email messaging. Data source 20 contains data about email contacts, and also contains data about the history of previously sent email messages between authorized users of the Company's email domain 37. It is essential that data source 20 contains the contact information of recipients and be operative for the storage and retrieval of sequence identifier 26 for each recipient. Within the present invention, data source 20 could be operative in several forms, including (i) a traditional relational database such as Microsoft. SQL

Server; or (ii) a delimited text file database containing the contact information of recipients and sequence identifier 26 for each recipient; or (iii) a data file containing the contact information of recipients and sequence identifier 26 for each recipient; or (iv) a record of previously sent emails (hereinafter referred to as the “email history”) stored in their native format within, or otherwise accessible by Sender A, Sender A's email application 18, and process 2; or (v) some other record of, or copy of, the email history that contains the contact information of recipients and sequence identifier 26 for each recipient.

Regardless of whether data source 20 is a traditional database, a data file, or an email history, it is accessible by and interoperable with the other components of the present invention, as described herein. Data source 20 includes data about the components of previously sent emails from Sender A to email recipients within the Company's email domain 37, and may also include the full or partial text and other data (e.g., MIME types) that comprise previously sent emails, including (i) email header fields such as subject line 36 and recipient email address 24, and (ii) the message body of previously sent email messages. Regardless of where data source 20 resides, or whether data source 20 is a traditional database or another form of accessible email history, its purpose is to contain information about previously sent emails, including the email addresses 26 of email recipients and sequence identifier 26 for each recipient, or next sequence marker 30 for each recipient, or both sequence identifier 26 and next sequence marker 30 for each recipient.

When used in the present invention, if data source 20 is an accessible email history of previously sent emails within the Company's email domain 37, the contact information of recipients and also sequence identifier 26 is retrievable or discernible. For example, by reading the email history, such as those found in a data folder of previously sent emails within email application 18 or located somewhere else on computing device 12, Sender A (manually) or process 2 (programmatically) could discern what the next sequence marker 30 would be.

Sender A's computing device 12 is a network-16-enabled device such as a desktop or laptop computer, a smartphone, tablet, smart TV, or another type of device. Computing device 12 uses email application 18, and possibly also process 2, to send emails to correspondents within the Company, such as Recipient B. Email application 18 may reside on the local computing device 12 or a local server, or be accessible via the network 16 (the “internet” or “cloud”). Computing device 12 and email application 18 also have access to a data source 20 (as a database or an accessible email history) that may reside on the local device 12, or a local server, or a local network, or somewhere within the cloud, or on the Company's email domain 37. Regardless of where data source 20 resides, whether it takes the form of a traditional database or an accessible email history, or how data source 20 components are accessed, data source 20 is operatively coupled to email application 18.

In any arrangement of data source 20 (as a database or an accessible email history) and email application 18, computing device 12 is configured to send email message(s) 22 from Sender A to Recipient B, and more particularly between computing devices 12 and 14 which are operated or otherwise controlled by Sender A and Recipient B, respectively, within the Company's email domain 37. Receiver B's computing device 14 is a network-16-enabled device such as a desktop or laptop computer, a smartphone, tablet, smart TV, or another type of device. Receiver B's computing device 14 has access to email application 18 which is part of the Company's email domain 37.

Names of email message recipients, email address(es) 24 and other relevant information about a plurality of contacts are stored in data source 20 (as a database or an accessible email history). Data source 20 is operatively coupled to sequence identifier 26. The function of sequence identifier 26 is to enumerate each email communication from Sender A to each of Sender A's individual recipient contacts and to maintain a component of data source 20 (as a database or an accessible email history) for each contact within the Company's email domain 37, such that every successive email from Sender A to each of its such contacts is identified by the next value in a predictable sequence that is, preferably, intuitively known and understood in the recipients' language and/or culture. In the example in FIG. 1, this predictable sequence consists of the standard Arabic whole numbers, and the number 76 represents the most recent sequence marker from the emails that have previously been sent from Sender A to Recipient B, and in this example the number 77 represents the next sequence marker 30 that would be used in a future email being sent from Sender A to Recipient B. Since the present invention has been designed to facilitate human recognition and human convenience, in this embodiment Sender A's sequence identifier 26 for its email correspondence with Recipient B consists of a simple incrementing Arabic numerical sequence. (In the first email communication from Sender A to Recipient B, a starting email sequence number would have to be used. This starting sequence number could be the Arabic numeral 1 or could be another number used to start a sequence.)

Recipient B may notice that the sequence marker for the most recent email correspondence was 76, and that, therefore, the sequence marker for the next legitimate and expected email from Sender A should be 77.

Alternative sequences from the sender's and recipient's language and culture would also operate effectively as other embodiments within the present invention: for example, Roman numerals, an alphabet, or a sequence derived from the words to a familiar poem or song. Another embodiment may utilize Multipurpose Internet Mail Extensions (“MIME”) types. Many email applications 18 can now be augmented with MIME types to support multimedia messages, and therefore would be able to expand the range of potential sequence markers significantly: for example, pictures or icons could be used to display a recognizable sequence. Internet Message Format (“IMF”) has been developed in step with Simple Mail Transfer Protocol and is standardized in RFC-5322. IMF is the standard syntax defined by the Internet Engineering Task Force (IETF) for the message bitstream when moving email messages from one computing device to another. As such, it is highly adopted and interoperable with many toolsets and applications. RFC-5322 Section 2.2, Header Fields, states: “Header fields are lines beginning with a field name, followed by a colon (“:”), followed by a field body and terminated by CRLF” and “Each header field is logically a single line of characters, comprised of the field name, the colon, and the field body.”

In this embodiment of the present invention, email senders also use process 2, which is an application or script used in conjunction with email application 18 to create and send emails to recipients within the Company's email domain 37.

Therefore, for the purposes of the present invention, the email application 18 that creates the single line of characters for the header field defined as “subject:” 36 (commonly referred to as the “subject line” of the email) would execute an alternative process 2 that programmatically inserts an appropriate next sequence marker 30 after the subject field name and colon that defines the header of subject line 36 and anywhere within the subject line 36. Thus, the next sequence marker 30 becomes embedded within and is part of email subject line 36. In addition to placing the next sequence marker 30 within the subject line 36 of the email message, the next sequence marker 30 could be inserted anywhere within the portion of the email that is visible to the recipient upon opening the email inbox in application 18; that is, in the areas reserved, pursuant to the specifications in RFC-5322 (and other RFC specifications for transporting email), for the name of the sender (known as “name:”) or near the beginning of the first text line of the body of the email.

Since in many email applications 18 the subject line 36 is immediately visible without the body of the email message being visible until the email message is actually opened, it is the best use of the present invention to have subject line 36 of the email be the location where the next sequence marker 30 would be inserted manually by Sender A using email application 18, or programmatically using process 2 and email application 18. Using the next sequential marker 30 in subject line 36 means it is easier for Recipient B to quickly and more easily identify a potential phishing attempt because Recipient B likely does not need to fully open email message 22 to see the next sequential marker 30. Application 18 and process 2 are configured to send email messages from computing device 12 to computing device 14 by extracting information from data source 20 (as a database or an accessible email history) and using the extracted information to fill various fields in email 22 before sending the email. For example, the email address 24 for Recipient B is extracted from data source 20 and inserted into the destination email address field 32 in email 22. In another embodiment of the present invention, Sender A manually reads information from data source 20 (as a database or an accessible email history) and manually fills in various fields in email 22, including using the next sequence marker 30 in the subject line 36 or in another part of the email, before sending the email using email application 18. Sender A could read the components of data source 20 (as a database or an accessible email history) to determine next sequence marker 30. In another embodiment of the present invention, Sender A could rely on other methods to track sequence identifier 26 and next sequence marker 30 for Recipient B and other contacts, such as (i) simply using human memory to track these; or (ii) tracking these using a written paper record; or (iii) tracking these using another database, computer application, or computer file stored on computing device 12 or another device or system accessible by Sender A; or (iv) tracking these using another method. In this alternative embodiment, instead of relying on process 2 to programmatically insert next sequence marker 30, Sender A could manually insert the next sequence marker 30 into the subject line 36, or into another part of the email, to help detect and prevent email phishing attempts by using sequential email numbering.

Email application 18, using process 2, also automatically inserts Sender A's name (“sender's name:” as defined in RFC-5322 and other protocols for transporting email) and email address 24 into the sender's email address field (“Sender:” as defined in RFC-5322 and other protocols for transporting email) 34 and the original subject text of the email into the “subject:” 36 field. In an alternative embodiment of the present invention, Sender A would manually insert the data for these email fields while constructing the email message using email application 18.

Application 18, process 2, and data source 20 (as a database or an accessible email history) then operate together to retrieve the last sequence identifier 26 for that recipient from the components in data source 20 and generate a new next sequence marker 30 by, in this embodiment, arithmetically increasing it by one from 76 to 77. Process 2 then updates the sequence identifier for Recipient B in data source 20, if appropriate, and stores or saves the sequence identifier 26, or next sequence marker 30; or both sequence identifier 26 and next sequence marker 30; or a marker, indicator or other data to represent or compute at a later time the value for either sequence identifier 26 or next sequence marker 30, or both; pending retrieval for the next email from Sender A to Recipient B. Other database components in data source 20 about the history of previously sent emails from Sender A to Recipient B may also be stored in data source 20 (as a database 20 or an accessible email history), along with the sequence identifiers and sequence markers; however, if data source 20 takes the form of an email history, then it might not be necessary to store or save information about sequence identifier 26 or next sequence marker 30 in the database components since the email history can simply be read when needed by Sender A or process 2 to determine what the sequence identifier 26 is and what the next sequence marker 30 will be.

When Sender A's email application 18 communicates to the Company's email domain 37, it may comply with IMF and SMTP, or it may use an alternate protocol, standard or proprietary method for transporting email. Alternatively, a web browser application may be used to communicate to an internet host that is coupled to the Company's email domain 37. In either case, the precise communication method between application 18 and the Company's domain 37 is not material for the purposes of the present invention. Regardless of how Sender A's application 18 and the Company's email domain 37 communicate, as the email leaves its host domain by means of SMTP, a simple, stripped-down IMF email in US-ASCII characters will look similar to this, as an example:
Sender: senderA.address@Companydomain.com
Message-ID: <000000000c5d058363538e@senderAdomain.com>
Date: Wed, 6 Mar. 2019 01:58:25+0000
Subject: Contributions for next week's webinar?
From: <senderA.address@Companydomain.com>
To: recipientB@Companydomain.com
Body: Melissa wants to know if we are going to give a progress report on our project, or wait for a while. Thoughts?

This above example, along with the examples below, is intended to show the header fields of a typical email message 22. These examples are presented in US-ASCII characters. RFC-5322 specifies that email “messages are made up of characters in the US-ASCII range of 1 through 127. There are other documents, specifically the MIME document series ([RFC2045], [RFC2046], [RFC2047], [RFC2049], [RFC4288], [RFC4289]), that extend this specification to allow for values outside of that range” (Section 2.1). Therefore, the present invention can utilize either US-ASCII characters, or the other data types or character sets in other standards that allow for values outside of the US-ASCII range of 1 through 127, to detect an email phishing attempt or fraudulent email using sequential email numbering.

If the next sequence marker 30 in the present invention has been applied (to the “subject:” line 36 in this example), the simple email IMF example will look like this as it leaves the Company's domain 37 by means of SMTP:
Sender: senderA.address@Companydomain.com
Message-ID: <000000000c5d058363538e@senderAdomain.com>
Date: Wed, 6 Mar. 2019 01:58:25+0000
Subject: 77-Contributions for next week's webinar?
From: <senderA.address@Companydomain.com>
To: recipientB@Companydomain.com

Body: Melissa wants to know if we are going to give a progress report on our project, or wait for a while. Thoughts?

In another example, the next sequence marker 30 in the present invention has been applied to the “subject:” line 36, but is not strictly at the beginning of the subject line:
Sender: senderA.address@senderAdomain.com
Message-ID: <000000000c5d058363538e@senderAdomain.com>
Date: Wed, 6. Mar 2019 01:58:25+0000
Subject: Contributions for next week's webinar?−77
From: <senderA.address@Companydomain.com>
To: recipientB@Companydomain.com
Body: Melissa wants to know if we are going to give a progress report on our project, or wait for a while. Thoughts?

This example demonstrates that the next sequential identifier 30 could be inserted within the subject line 36 immediately after the header (“Subject :”) or anywhere within the subject line 36, including in the middle or at the end of the subject line 36. The next sequence marker 30 is thus added to the original text intended for the “subject:” line 36 and the combined text is inserted into the “subject:” line 36. The next sequence marker 30 could be at the beginning of the text of the subject line, anywhere within the subject line text, or at the end of the subject line text, as demonstrated in the following three examples: (i) Subject: 77-Contributions for next week's webinar? (ii) Subject: Contributions for next week's webinar?−77; and (iii) Subject:

Contributions −77-for next week's webinar? The present invention inserted next sequence marker 30 into the email subject line 36, programmatically by process 2, when email message 22 was created by Sender A with the interoperable data source 20 (as a database or an accessible email history) and email application 18. In another embodiment of the present invention, Sender A could have determined the next sequence marker 30 by referencing the components in data source 20 and manually creating an email message using email application 18 (without using process 2) and manually inserting the next sequence marker 30 within the subject line 36. In further embodiments, other applications running on the email server or interoperating with the email domain 37 could have intercepted the email at a later stage and inserted the next sequence marker 30 programmatically, prior to the email being transmitted to the recipient, if no sequence marker 30 was found in the subject line 36 or in another email message header field, message body, or any other part of the email message. Furthermore, the next sequence marker 30 is not limited to being in subject line 36 and so it could be placed: (i) anywhere within the sender's name field (“Sender:”) which, as described in RFC-5322, Section 3.4, is an email header field for “an optional display name . . . (which can be a person or a system) that could be displayed to the user of a mail application”; or (ii) somewhere within the beginning of the body of the email message, because often this area is used for preview text (e.g., where the first few characters of the email body are visible without opening the full email message); or (iii) in other areas within the body field of the email message, such that the human user (in this case Recipient B) would be assisted to recognize and comprehend the significance of the sequence identifier within his email inbox without requiring any other process; or (iv) in any other part of the email message, whether visible or invisible to the human end-user, including in required header fields, or in optional header fields, or in the body of the email message, so long as inclusion of the next sequence marker 30 in a given location does not interfere with the syntax or other requirements of the email message components, and does not materially interfere with the proper functioning of email messaging using the RFC-5322 protocol and other standards for transporting email; or (v) into a separate, custom application, whether proprietary or sourced from a third party, that has been configured to meet the Company's email sending needs.

All of these placement locations for next sequence marker 30 are suitable for use with RFC-5322 since the protocol allows for substantial customizability and extensibility, because “The only required header fields are the origination date field and the originator address field(s). All other header fields are syntactically optional” (Section 3.6) and, furthermore, “This specification is not intended to dictate the internal formats used by sites, the specific message system features that they are expected to support, or any of the characteristics of user interface programs that create or read messages. In addition, this document does not specify an encoding of the characters for either transport or storage” (Section 1.1).

Although the next sequence marker 30 could be inserted anywhere within the email 22, as described above, if the next sequence marker 30 were located within subject line 36, this would be in keeping with the RFC protocols and related standards for email messaging: as set forth in RFC-5322, Section 3.6.5, the subject line 36 is “intended to have only human-readable content with information about the message” and so acts an appropriate container for next sequence marker 30 and allows the present invention to function properly without deviating from

RFC-5322 and related standards for transporting email messages. The present invention assists its human users in recognizing and understanding the significance of sequence identifier 26 and sequence marker 30 (which in this embodiment are similar to page numbers). Once the human user has recognized or learned of the significance of the sequence identifier(s), no further or prior specialized knowledge is required. Recipient B may be assisted in understanding that an email purporting to be from Sender A but that is lacking either the correct next sequence marker 30 or any sequence marker at all may be a phishing or fraud attempt and should be considered to be suspicious and worthy of further investigation. This assistance could come if some combination of email application 18, data source 20 (as a database or an accessible email history) and process 2 alerted Recipient B if the next sequential marker 30 that was received as part of email message 22 did not match the expected sequential identifier; that is, if the sequence were out of order. Email application 18, interoperating with other components, could, for example, change the email message to a different colour, alert Recipient B using an on-screen message on computing device 14, or otherwise provide a notification to Recipient B that an email might be a potential email phishing attempt and should be treated as a suspicious email message. Recipient B could also instead manually compare the next sequence marker 30 to sequence identifier 26 to determine whether an email is a potential phishing or fraud attempt. The present invention thus allows Recipient B, an authorized user of a corporate email domain, to detecting email phishing attempts, or other fraudulent emails, using sequential email numbering and the other components and processes of the present invention.

In another embodiment of the present invention, Sender A's outgoing emails, including emails being sent to contacts outside of Sender A's email domain 37, are sequentially numbered so such external contacts may benefit from sequential email numbering to detect phishing attempts and/or other fraudulent emails. In this embodiment, even though the external recipient may not be within the same email domain as Sender A, sequential email numbering may help the external recipient notice potential phishing attempts where a bad actor may be impersonating Sender A or another email sender within Sender A's email domain 37. In this embodiment, the external recipient's email application or email domain may or may not have the ability to automatically flag suspicious emails, depending on whether this external email domain also uses the sequential email numbering and other components and processes of the present invention.

In another embodiment of the present invention, namely intercepting the email at the sender's email domain 37, the email domain 37 may insert the next sequence marker 30 if no sequence identifier is detected in a sender's email, thus providing the email domain's user base with the means to identify and prevent email phishing attempts.

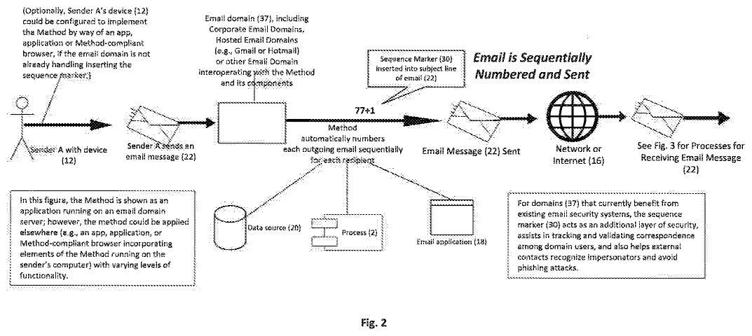

FIG. 2 depicts components of and processes for sending email with the method of using sequential email numbering to detect email phishing attempt or fraudulent emails within email domains (37), including corporate email domains, hosted email domains (e.g., Gmail or Hotmail) or other email domains interoperating with the method and its components. The method components automatically number each outgoing email sequentially for each email recipient. Sequence marker (30) is inserted into the subject line of each outgoing email (22) for that domain (37), resulting in emails being sequentially numbered and sent at the domain level.

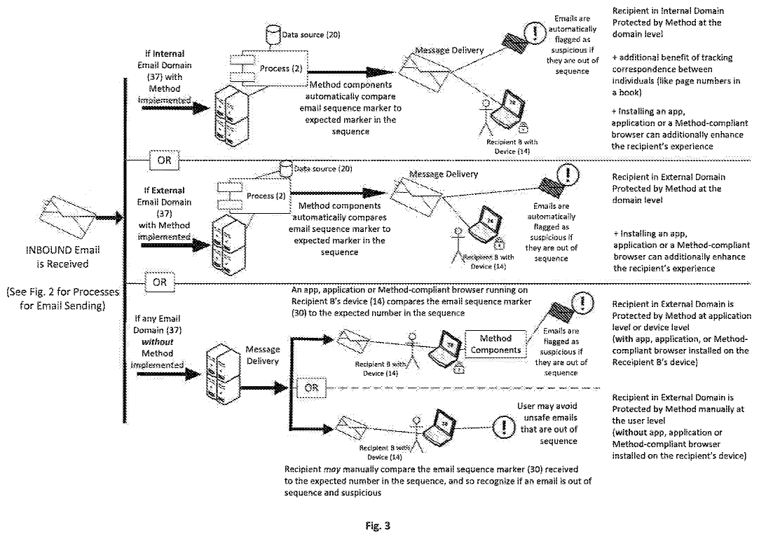

FIG. 3 depicts components of and processes for receiving email with the method of using sequential email numbering to detect email phishing attempts or fraudulent emails within email domains. There are variations in the process, depending on whether the email is received by an email domain that implements the method at the domain level, at the application or device level, or at the recipient level:

(a) When an email is received within the same or “internal” email domain (37) that sent the message, since that internal domain implements the method at the domain level, the components automatically compare the email sequence marker to the expected marker in the sequence and emails are automatically flagged as suspicious phishing or fraud attempts if they are out of sequence.

(b) When an email is received within a different or “external” email domain (37) than that which sent the message, since that external domain also implements the method at the domain level, the components automatically compare the email sequence marker to the expected marker in the sequence and emails are automatically flagged as suspicious phishing or fraud attempts if they are out of sequence.

(c) When an email is received within a different or “external” email domain (37) than that which sent the message, if that external domain does not implement the method at the domain level, then an app, application or method-compliant browser running on Recipient B's device (14) may still compare the email sequence marker (30) to the expected number in the sequence and em ails are automatically flagged as suspicious phishing or fraud attempts if they are out of sequence. But, when an email is received within a different or “external” email domain (37) than that which sent the message, if that external domain does not implement the method at the domain level and there is not an app, application or method-compliant browser running on Recipient B's device (14), the Recipient B may still notice and manually compare the email sequence marker (30) to the expected number in the sequence and emails that are out of sequence may be avoided, keeping the recipient safe even if the email is not automatically flagged as a suspicious phishing or fraudulent email attempt.

A specific embodiment of the present invention has been disclosed; however, several variations of the disclosed embodiment could be envisioned as within the scope of this invention.

It is to be understood that the present invention is not limited to the embodiments described above but encompasses any and all embodiments within the scope of the following claims.

Therefore, what is claimed is:

1. A method of verifying the authenticity of emails sent within a email domain from a first email application of a sender to a second email application of a recipient, both sender and recipient being within the same email domain, the emails each having a sender's email address, a receiver's email address, and a user-accessible field for receiving content, the content of the user-accessible field being visible to the recipient upon opening an email inbox in the second email application, the method comprising the steps of:
Identifying the receiver for an email to be sent by the sender;
generating a current sequence marker for the receiver, the current sequence marker representing a next sequence identifier in a sequence of emails between the sender and the receiver;
inserting the current sequence marker into the user-accessible field of the email and then sending the email to the recipient.

2. The method of claim 1 wherein the current sequence marker is generated from an email history representing a record of emails previously sent from the sender to the recipient.

3. The method of claim 2 wherein the current sequence marker comprises one or more characters selected from the group of sequential characters comprising letters, numbers, words from a sequential list of words, symbols from a sequential list of symbols, icons from a sequential list of icons and images from a sequential list of images.

4. The method of claim 1 wherein the email history is contained in a database coupled to the first email application.

5. The method of claim 4 wherein the database and first email application are configured to programmatically generate the current sequence marker and insert it into the user-accessible field before sending the email.

6. The method of claim 1 wherein the sender queries an email history to generate the current sequence marker, the email history representing a record of emails previously sent from the sender to the recipient, the sender then inserting the current sequence marker into the user-accessible field before sending the email.

7. The method of claim 6 wherein the email history includes a last sequence marker for a last email sent to the recipient, the sender generating the current sequence marker by incrementing the last sequence marker by 1.

8. The method of claim 1 wherein the user-accessible field into which the current sequence marker is inserted is a subject field for the email.

9. The method of claim 7 further comprising the steps of the recipient receiving the email sent by the sender, the current sequence marker being identified from the email, the current sequence marker then being compared to an expected sequence marker predicted from the last sequence marker, the email being flagged as suspicious if the current sequence marker identified from the email does not match the expected sequence marker.

10. The method of claim 1 wherein the current sequence marker is a human-readable alphanumeric sequence of characters.

11. The method of claim 1 further comprising sender and receiver databases coupled to the sender and receiver email application, the sender and receiver databases containing fields for the email addresses_of senders and recipients, the last sequence identifier used in a sequence of emails, the current next sequence identifier to be used for the next email in the sequence of emails, the sender and receiver_databases being further configured to automatically update the current sequence identifier in the sender database to reflect the sending of the email when the email is sent from the sender, and to automatically update the predicted sequence identifier in the receiver database in the event the sequence identifier extracted from the email received matches the predicted sequence identifier fetched from the receiver database.

12. A method of verifying the authenticity of emails sent from a sender to a receiver within an email domain, the emails each having a sender's email address, a receiver's email address, and a user-accessible field; the method comprising the steps of:
identifying a receiver for an email to be sent by the sender;
generating a current sequence marker for the receiver, the current sequence marker representing a next sequence identifier in a sequence of emails between the sender and the receiver;
inserting the current sequence identifier into the user-accessible field of the email and then sending the email;
identifying the sender of the email when the email is received by the receiver;
identifying the current sequence identifier from the email;
generating a predicted sequence identifier for the sender;
comparing the current sequence identifier identified from the email to the predicted sequence identifier, and
flagging the email as suspicious in the event the sequence identifier identified from the email does not match the predicted sequence identifier.

13. The method of claim 12 wherein the user-accessible field into which the current sequence identifier is inserted is configured such that the receiver can view the current sequence identifier simply by reading the user-accessible field without having to open the email, the receiver's email application being configured to flag the email as suspicious if the current sequence marker identified from the email does not match the expected sequence marker.

14. An email system for sending a plurality of emails from a sender to a receiver within a same email domain, the emails each having a sender's email address, a receiver's email address and a user-accessible field, the email system comprising:
a sender email application operatively coupled to a sender database, the sender email application configured to send emails to the receiver, the sender database configured to store contact information for the receiver including the receiver's email address and a sequence identifier, the sequence identifier representing a last predicted value in a previously agreed-upon sequence of emails between the sender and receiver, the sender database and the sender email server configured to insert the sequence identifier for the receiver in the user-accessible field of each email sent to the receiver, the sender database being further configured to update the sequence identifier for the receiver in the sender database when each email is sent to the receiver;
a receiver email application operatively coupled to a receiver database, the receiver email application configured to receive said plurality of emails from the sender, the receiver database configured to store contact information for the sender including the sender's email address and the sequence identifier, the receiver email application and receiver database configured to parse the email to extract the sequence identifier from the user-accessible field of the email sent from the sender to generate an extracted sequence identifier, the receiver email application and receiver database being further configured to fetch the sequence identifier for the sender from the sender database and compare the extracted sequence identifier to the fetched sequence identifier and flag the email as suspicious if the extracted sequence identifier does not match the fetched sequence identifier;
parsing the text field of the email to extract the current sequence identifier from the email;
identifying the sender of the email in a receiver database and fetching a predicted sequence identifier from the receiver database for the sender;
comparing the current sequence identifier extracted from the email to the predicted sequence identifier fetched from the receiver database, and
flagging the email as suspicious in the event the sequence identifier extracted from the email does not match the predicted sequence identifier fetched from the receiver database.

15. The method of claim 1 wherein the sender is within the email domain but the recipient is within a different email domain.

16. The method of claim 1 wherein the sender is within an email domain but the recipient is within the email domain of a web-based email service provider, such as Yahoo Mail, Gmail, Hotmail or others.

17. The method of claim 1 wherein the sender is within the email domain of a web-based email service provider but the recipient is within a different email domain.

18. The method of claim 1 wherein the sender and receiver are both within the email domain of a web-based email service provider,

19. The method of claim 12 wherein a recipient's email domain flags emails as suspicious in the event the sequence identifier identified from the email does not match the predicted sequence identifier, the recipient having a different email domain than the email sender.

20. An email system for receiving emails sent from a sender in an email domain to a receiver within a different email domain, the emails each having a sender's email address, a receiver's email address and one or more user-accessible fields, the email system comprising:
the receiver email application operatively coupled to a receiver database of email contacts, the receiver database configured to store contact information for the receiver including the sender's email address and a sequence identifier, the sequence identifier representing a last predicted value in a previously agreed-upon sequence of mails between the sender and receiver, the receiver database and the receiver email server configured to inspect the incoming email and identify the sequence identifier for the sender in the user-accessible field of each email sent to the receiver, the receiver database being further configured to update the sequence identifier for the sender in the receiver database when each email is sent to the receiver;
a receiver email application operatively coupled to a receiver database, the receiver email application configured to receive said plurality of emails from the sender, the receiver database configured to store contact information for the receiver including the sender's email address and the sequence identifier, the receiver email application and receiver database configured to parse the email to extract the sequence identifier from the user-accessible field of the email sent from the sender to generate an extracted sequence identifier, the receiver email application and receiver database being further configured to compare the extracted sequence identifier to the predicted sequence identifier in the receiver database and then either flag the email as suspicious if the extracted sequence identifier does not match the predicted sequence identifier or, if this is the first sequence identifier ever received in an email from the sender, to update the sequence identifier in the database so future emails can be validated using sequential numbering and the other components and processes of the present invention;
parsing the text field of the email to extract the current sequence identifier from the email;
comparing the current sequence identifier extracted from the email to the predicted sequence identifier fetched from the receiver database, and either flagging the email as suspicious in the event the sequence identifier extracted from the email does not match the predicted sequence identifier fetched from the receiver database or, if this is the first sequence identifier ever received from the sender, to update the sequence identifier in the receiver database so future emails can be validated using sequential numbering and the other components and processes of the present invention; and
in the event a sequence identifier cannot be parsed or extracted from the email, flagging that email as not conforming to the method of using sequential email numbering, and thus as not verifiable or possibly suspicious.
